(19) United States
(12) Patent Application Publication
(10) Pub. No.: US 2025/0384436 A1
(43) Pub. Date: Dec. 18, 2025

(54) SYSTEMS AND METHODS OF FACILITATING PROTECTION OF A DIGITAL VAULT AGAINST AN UNAUTHORIZED ACCESS

(71) Applicant: BitVaulty Inc., Wilmington, DE (US)

(72) Inventor: Francesco Madonna, Paradiso (CH)

(21) Appl. No.: 19/211,938

(22) Filed: May 19, 2025

Related U.S. Application Data
(60) Provisional application No. 63/659,247, filed on Jun. 12, 2024.

(51) Int. Cl. G06Q 20/38; G06Q 20/36; G06Q 20/40; H04L 9/32

(52) U.S. Cl. CPC G06Q 20/3825; G06Q 20/36; G06Q 20/401; H04L 9/3247

(57) ABSTRACT

The present disclosure provides a method of facilitating protection of a digital vault against an unauthorized access. Further, the method may include receiving an indication data corresponds to an indication for accessing the digital vault. Further, the method may include generating an authentication request data based on the indication data. Further, the method may include transmitting the authentication request data to a predefined authorized user. Further, the method may include receiving the authentication response data. Further, the method may include determining a time instance of the authentication response data based on the receiving of the authentication response data. Further, the method may include analyzing the time instance based on a predefined time interval. Further, the predefined time interval represents a time interval for receiving the authentication response data. Further, the method may include processing the accessing of the digital vault based on the analyzing.

### FIELD OF DISCLOSURE

The present disclosure generally relates to a field of data processing. More specifically, the present disclosure relates to systems and methods of facilitating protection of a digital vault against an unauthorized access.

### BACKGROUND

The rapid evolution of digital systems has revolutionized how we manage and transact financial assets. As reliance on digital platforms grows, so does the need for robust security measures to protect sensitive information and transactions from malicious actors. The field of transaction security is pivotal in ensuring that users can conduct their financial activities with confidence, safeguarding against unauthorized access, fraudulent transactions, and data breaches.

One of the most critical objectives in this domain is to provide users with a controlled window to review and potentially cancel suspicious transactions before they are finalized. This objective is essential for empowering individuals to take timely action against potential threats, such as compromised credentials or unanticipated account activities. Without such a mechanism, users may find themselves vulnerable to irreversible financial losses due to overlooked suspicious transactions.

Current systems often fall short in addressing this need effectively. Traditional transaction systems typically lack built-in delays, making it challenging for users to detect and respond to suspicious activities promptly. Moreover, existing solutions may employ static rules for AI-driven threat detection, which fail to adapt to evolving attack methods. Encryption methods, while crucial, may not be quantum-resistant, leaving them vulnerable as computational advancements progress. Additionally, notification systems may lack customization options, limiting their effectiveness in real-time scenarios.

Existing cryptocurrency security method may rely on either single-signature wallets, which are vulnerable to key theft, or multisig wallets, which, while more secure, do not inherently prevent unauthorized transactions once keys are compromised. Traditional password-based authentication is susceptible to credential theft, phishing, and insider threats. One of the fundamental weaknesses in the current cybersecurity industry is the lack of a fully reliable and tamper-proof universal time provider. Existing security systems rely on centralized servers or third-party timestamp authorities (e.g., NTP servers, internal clocks), which can be hacked, manipulated, or desynchronized, leading to potential exploits in time-based access control mechanisms.

Therefore, there is a need for improved systems and methods of facilitating protection of a digital vault against an unauthorized access, that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating protection of a digital vault against an unauthorized access. Further, the method may include receiving, using a communication device, an indication data from a user device. Further, the indication data corresponds to an indication for accessing the digital vault associated with a digital asset. Further, the method may include generating, using a processing device, an authentication request data based on the indication data. Further, the authentication request data corresponds to a request for approval of the accessing. Further, the method may include transmitting, using the communication device, the authentication request data to a predefined authorized user device associated with a predefined authorized user. Further, the predefined authorized user device may be associated with the digital vault. Further, the method may include receiving, using the communication device, an authentication response data from the predefined authorized user device. Further, the authentication response data corresponds to a response to the request for approval of the accessing. Further, the method may include determining, using the processing device, a time instance of the authentication response data based on the receiving of the authentication response data. Further, the method may include analyzing, using the processing device, the time instance based on a predefined time interval. Further, the predefined time interval represents a time interval for receiving the authentication response data. Further, the method may include processing, using the processing device, the accessing of the digital vault based on the analyzing. Further, the time instance lies within the predefined time interval.

The present disclosure provides the system of facilitating protection of a digital vault against an unauthorized access. Further, the system may include a communication device. Further, the communication device may be configured for receiving an indication data from a user device. Further, the indication data corresponds to an indication for accessing the digital vault associated with a digital asset. Further, the communication device may be configured for transmitting an authentication request data to a predefined authorized user device associated with a predefined authorized user. Further, the predefined authorized user device may be associated with the digital vault. Further, the communication device may be configured for receiving an authentication response data from the predefined authorized user device. Further, the authentication response data corresponds to a response to the request for approval of the accessing. Further, the system may include a processing device communicatively coupled with the communication device. Further, the processing device may be configured for generating the authentication request data based on the indication data. Further, the authentication request data corresponds to a request for approval of the accessing. Further, the processing device may be configured for determining a time instance of the authentication response data based on the receiving of the authentication response data. Further, the processing device may be configured for analyzing the time instance based on a predefined time interval. Further, the predefined time interval represents a time interval for receiving the authentication response data. Further, the processing device may be configured for processing the accessing of the digital vault based on the analyzing. Further, the time instance lies within the predefined time interval.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating protection of a digital vault against an unauthorized access, in accordance with some embodiments.

FIG. 3B illustrates a continuation of the flowchart of the method 300 of facilitating protection of a digital vault against an unauthorized access, in accordance with some embodiments.

FIG. 4 illustrates a flowchart of a method 400 of facilitating protection of a digital vault against an unauthorized access including generating, using the processing device 804, the predefined authentication procedure data, in accordance with some embodiments.

FIG. 5 illustrates a flowchart of a method 500 of facilitating protection of a digital vault against an unauthorized access including analyzing, using the processing device 804, the user data, in accordance with some embodiments.

FIG. 6 illustrates a flowchart of a method 600 of facilitating protection of a digital vault against an unauthorized access including generating, using the processing device 804, an operation data, in accordance with some embodiments.

FIG. 7 illustrates a flowchart of a method 700 of facilitating protection of a digital vault against an unauthorized access including generating, using the processing device 804, an alert data, in accordance with some embodiments.

FIG. 8 illustrates a block diagram of a system 800 of facilitating protection of a digital vault against an unauthorized access, in accordance with some embodiments.

FIG. 9 illustrates a flowchart of a method 900 of facilitating protection of a digital vault against an unauthorized access including analyzing, using the processing device 804, the rejection data, in accordance with some embodiments.

FIG. 10 illustrates a flowchart of a method 1000 of facilitating protection of a digital vault against an unauthorized access including analyzing, using the processing device 804, the requirement data, in accordance with some embodiments.

FIG. 11 illustrates a flowchart of a method 1100 of facilitating protection of a digital vault against an unauthorized access including analyzing, using the processing device 804, the modified time delay data, in accordance with some embodiments.

FIG. 12 illustrates a flowchart of a method of time delayed and multisig-enhanced security solution for digital assets management, in accordance with some embodiments.

FIG. 13 illustrates a simplifies end-view of the user interface of the user wallet, in accordance with some embodiments.

FIG. 14 illustrates a simplified end-view of the transaction scheduler, in accordance with some embodiments.

FIG. 15 illustrates a simplified end-view of the notification dispatcher, in accordance with some embodiments.

FIG. 16 illustrates a simplified end-view of the cosigning service, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes BitVaulty. BitVaulty leverages the robust security features of the Bitcoin Liquid Network to provide an advanced cybersecurity solution. The core of this solution is based on a time-distributed multi-signature mechanism that ensures access to sensitive data or digital assets is controlled, monitored, and recorded immutably. Additionally, the Liquid Network's use of confidential transactions ensures that transaction amounts are hidden, adding an extra layer of privacy. The following are the key features of the BitVaulty:
1. Multi-signature Security:
   Accessing the vault requires multiple cryptographic signatures from different authorized parties. This ensures that no single entity can unilaterally access the vault.
   For example, the vault can be set to require three signatures: Signature A, Signature B, and Signature C.
2. Time-Distributed Access:
   The opening of the vault is time-distributed across several blocks on the Liquid Network. Each signature must be provided within a specific block interval. Example Timing:
   Signature A: Must be provided at block height To +2.
   Signature B: Must be provided at block height To +3.
   Signature C: Must be provided at block height To +4.
   Failure to Comply: If these conditions are not met, the vault cannot be opened, providing an additional layer of security against unauthorized access.
3. Blockchain Recording and Notifications:
   Immutable Record: The time and details of each attempt to open the vault are recorded on the Liquid Network, creating an immutable and transparent log of access attempts.
   Confidential Transactions: The Liquid Network's use of confidential transactions ensures that the amounts involved in any transaction are hidden, adding an extra layer of privacy and security.
   Secret Notifications: A secret notification system is triggered upon each attempt to access the vault. Running on the Liquid Network, this notification system is highly reliable and cannot be stopped, ensuring that stakeholders or security systems are alerted in real-time, allowing for immediate response to potential security breaches.

### Technical Feasibility of the BitVaulty:

1. Core Technologies:
   Liquid Network: Utilizes the enhanced security, confidentiality, and transaction speed of the Liquid Network for recording and validating access attempts.
   Multi-signature Wallets: Implements multi-signature technology, which is well-established and supported by various libraries and tools on the Liquid Network.
   Time-Locks: Uses Liquid's scripting capabilities, specifically Check Lock Time Verify (CLTV) and Check Sequence Verify (CSV), to enforce time-delayed access.
   Confidential Transactions: Leveraging Liquid's confidential transactions to hide transaction amounts, enhancing privacy and security.
2. Implementation Steps:
   Define Multisig Parameters: Set up the multi-signature scheme with required signatures and their respective timing.
   Integrate Time-Locks: Implement time-lock scripts to enforce the specific block intervals for each signature.
   Blockchain Interaction: Develop or utilize existing libraries for interacting with the Liquid Network to record access attempts and trigger notifications.
   Notification System: Implement a notification mechanism on the Liquid Network to ensure it is reliable and cannot be stopped, providing secure alerts of access attempts.
3. Challenges:
   Complexity in Timing Coordination: Ensuring that all required signatures are provided within the specific block intervals can be technically challenging and requires precise coordination. This can be offset by aggregating the transactions every N blocks.
   Scalability: Managing a large number of access attempts and notifications efficiently can be complex and may require robust infrastructure. This can be offset by aggregating the transactions every N blocks.
   Security of Notifications: Ensuring that the notification system itself is secure and cannot be tampered with is crucial.

### Evaluation of Technical Feasibility:

1. Liquid Network: Highly feasible due to its enhanced security, confidentiality, and reliability.
2. Multi-signature and Time-Locks: Technically feasible with existing Liquid Network scripting and wallet technologies.
3. Notification System: Feasible and reliable on the Liquid Network, ensuring notifications cannot be stopped.
Overall Feasibility Rating: High
Service Rating: Very high
   Security: High level of security due to multi-signature and time-distributed access.
   Transparency: Immutable recording on the Liquid Network provides transparency and auditability.
   Privacy: Confidential transactions ensure that transaction amounts are hidden, adding an extra layer of privacy.
   Usability: Requires precise coordination but offers robust protection against unauthorized access.

BitVaulty's cybersecurity solution, leveraging multi-signature and time-distributed access controlled by the Liquid Network, offers a highly secure and transparent method for protecting sensitive data. Its technical feasibility is strong, with well-established technologies supporting the core functionalities. The service provides a high level of security, transparency, and privacy, making it an excellent solution for enhancing cybersecurity in various applications. The added reliability of the secret notification system running on the Liquid Network ensures that alerts are timely and cannot be stopped, further enhancing the security and responsiveness of the solution.

Further, the present disclosure describes time-delayed transaction authorization and multi-signature verification system for enhanced bitcoin wallet security. Further, the present disclosure describes a novel security solution for Bitcoin holders utilizing non-custodial wallets, addressing prevalent issues of unauthorized access due to hacking attempts and physical coercion. The system innovatively combines time-delayed transaction authorization with a multi-signature (multisig) verification protocol to create a secure environment for Bitcoin storage and transfer. It employs advanced encryption methodologies and a user-friendly interface to safeguard users' digital assets, significantly reducing the likelihood of illicit withdrawals and enhancing the overall integrity of Bitcoin transactions.

The system addresses the following problems:
Security Vulnerabilities: Bitcoin wallet users, particularly those using non-custodial wallets, face risks from hacking and physical threats. Existing security measures often fail to prevent unauthorized access or provide sufficient time for users to react to security breaches.
Need for Enhanced Control: Users require a system that empowers them with immediate alerts and additional time to intercept potential unauthorized transactions.
   The system addresses the problems by following key features:
Time-Delayed Transaction Authorization: The system introduces a mandatory, user-configurable delay period for all outgoing transactions, which cannot be modified once initiated. This buffer period allows users to review and potentially cancel any suspicious transactions, providing an effective defense against both digital and physical security breaches.
Multi-signature Verification Protocol: Transactions require authorization from multiple, independent signatories pre-selected by the user, thus distributing control and adding an extra security layer that makes unauthorized access exponentially more challenging.
Secret Notification Protocol: The system includes a proprietary alert mechanism that communicates with a user-designated “external owl wallet,” signaling any unexpected transaction activities or access attempts through encrypted channels for swift and secure user notification.
Confidential Transactions: Transaction amounts and access request details remain hidden, preserving privacy.
Host-Client Interface with Encrypted API: The system operates via a secure host-client architecture, ensuring communication security through an encrypted API, or Liquid Network's AMP API for enhanced authentication and privacy.
   The following are the components and methodological steps:
User Interface (UI): An intuitive interface allows users to manage Bitcoin transactions, set time delays, and establish multisig configurations.
Transaction Scheduler: This backend component enforces the user-set delay for transactions and manages the queuing and timed release of transaction approvals. Further, this backend component manages the countdown and blocking the transaction execution until the delay period has expired
Notification Dispatcher: In the event of transaction initiation or unusual account activity, this module sends out real-time, encrypted alerts to the user's secondary device or chosen ‘external owl wallet,’ enabling prompt user action.
Signature Verifier: Coordinates the collection of required multisig approvals from the configured signatories and authenticates each before the transaction proceeds.
Encryption Module: Secures transaction data, user settings, and cryptographic keys to ensure comprehensive protection of user assets.
   The following are the assembly and process flow integration:
Configuration Phase: Users personalize the security settings in the UI, setting up the system according to their security preferences.
Initiation to Verification: When a transaction is initiated, the Transaction Scheduler begins the delay countdown, while the Notification Dispatcher alerts the user, the signatories and the pre-selected “owl wallets” which act as sentinels. The user can approve or cancel the transaction during this window.
Approval Collection and Execution: The Signature Verifier assembles and verifies all necessary approvals during the delay period. Upon successful multisig authentication and lapse of the delay period, the transaction is finalized and broadcast to the Bitcoin network.
Data Protection: The Encryption Module actively encrypts all sensitive data within the system, safeguarding the information against unauthorized access and maintaining the integrity of the entire operation.
   The following software components are integrated to function seamlessly:
The UI allows users to manage their Bitcoin transactions and settings, directly interfacing with the Transaction Scheduler to implement the security measures.
Upon transaction initiation, the Transaction Scheduler activates the time delay, while the Notification Dispatcher informs all necessary parties of the pending transaction.
The Signature Verifier plays a crucial role during the delay period, ensuring that all transactions receive the requisite verified signatures before proceeding to execution.
The Encryption Module continuously secures sensitive data within the system, operating in conjunction with all components to maintain the integrity of user assets and information.

This security solution pertains to the technical field of digital asset management and security, particularly addressing the need for improved protective measures in Bitcoin transactions facilitated through non-custodial wallets.

Further, the cybersecurity service operates on a Host-Client interface, where the two are connected via encrypted API. If implemented on the Liquid Network, the system utilizes the native encrypted API AMP (or its latest versions) for secure communication and authentication.

Further, the system leverages Bitcoin network as an incorruptible source of universal time. Bitcoin's block timestamps, secured by Proof-of-Work consensus, serve as an immutable and globally verifiable time reference, eliminating the risk of manipulated or forged timestamps. This ensures that time-delayed authentication and security mechanisms operate in a trustless and attack-resistant manner, making it impossible for malicious actors to accelerate, bypass, or forge time-based security policies.

This system may introduce unique technological advancements in digital asset security and cybersecurity protection by implementing:
1. User-Centric Protection Instead of Passive Security Measures:
   Unlike traditional security models that rely on detecting breaches after they occur, this system enforces preemptive security by delaying execution of sensitive actions, allowing for intervention before a security breach is finalized.
2. Trustless Convenience Service:
   The system provides an optional self-hosted or managed convenience service, ensuring users can retain full control over their security settings while benefiting from automated protection layers.
3. Secret Notifications for Proactive Defense:
   The security system integrates encrypted notifications that are triggered before an unauthorized transaction or access occurs, allowing users and security teams to respond immediately.
4. Immutable Blockchain Audit Logs:
   Every access attempt and transaction request is permanently recorded on a tamper-proof blockchain ledger, providing a transparent, trustless security record.
5. Broad Applicability to Cybersecurity:
   While the system is designed to secure cryptocurrency transactions, it extends to cybersecurity environments, preventing unauthorized system access and enforcing time-distributed authentication policies.
6. Host-Client Encrypted API with Secure Communication:
   The system operates on a secure communication model, using encrypted APIs for authentication and data transfer. If deployed on the Liquid Network, the AMP API (or its latest versions) is leveraged for enhanced security.

Further, the present disclosure corresponds to a wallet software solution and a wallet app which work on a multisig wallet with customizable signature setup combinations (2-of-2, 2-of-3, 3-of-5, 4-of-7, 5-of-9 and so forth) cosigned by a convenience server. The transaction which is being initiated on the app needs to be cosigned by the convenience service to be broadcasted, according to the specific setup combination of the multisig wallet.

For instance, in the 2-of-2 configuration, a time delay between the two signatures is being applied. As soon as the first part of the transaction is being built, a push notification with a secret message appears on the app of the “owl wallet” previously set. The time-delay can be changed just after the same timeframe equal to the delay has passed. A popup at every app opening/unlocking alerts the attackers that the wallet has a time delay setting, therefore attackers have no way to proceed with the settlement of any transaction and shall cease the attack.

Further, the system may combine traditional encryption with quantum-resistant algorithms to ensure future-proof security. Further, the system may implement next-generation cryptographic technique designed to withstand quantum computing threads. Further, the system may remain secure against emerging computational advancement.

Further, the system may adjust delay period in real-time based on factors such as user location, device type, and transaction volume. Further, the system may facilitate a context aware delay. Further, the system may monitor transaction activity in real-time, updating the risk score based on new data as it become available.

Further, the system may combine multiple data points such as user behavior, device reputation, and transaction history to provide a comprehensive risk assessment.

Further, the system may require user to authentication using a combination of factors such as something you know, something you have, and something you are.

Further, the system may use biometric verification throughout the transaction process to ensure ongoing user presence and authorization.

Further, the system may allow users to specific times for receiving notifications based on their personal preferences and transaction timing.

Further, the system may deliver critical alerts immediately while allowing non-critical notifications to be delayed or grouped together.

Further, the system may deploy monitoring nodes across multiple jurisdictions to track and alert on suspicious activities globally.

Further, the system may trigger alerts automatically when a transaction involves parties in different jurisdictions, ensuring comprehensive oversight.

Further, the system may redesign the user interface to be more user-friendly and accessible, reducing the likelihood of errors during high-stakes transactions.

Further, the system may provide immediate feedback to users on the status of their transactions and any necessary actions required for confirmation or cancellation.

Further, the system may aggregate and analyze data from multiple users to identify patterns indicative of suspicious activity.

Further, the system may use collective user behavior data to predict potential threats and trigger delays or alerts accordingly.

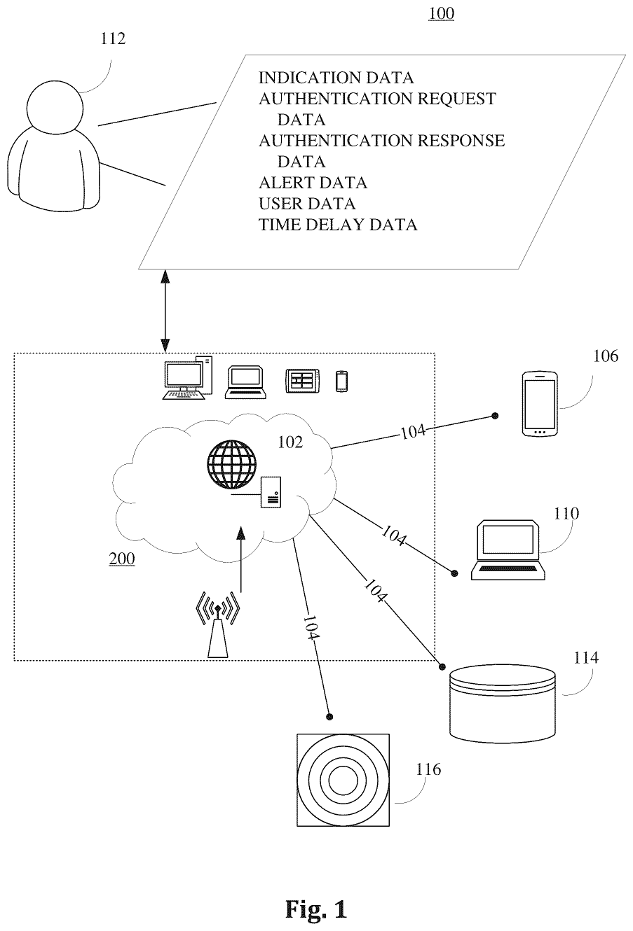

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

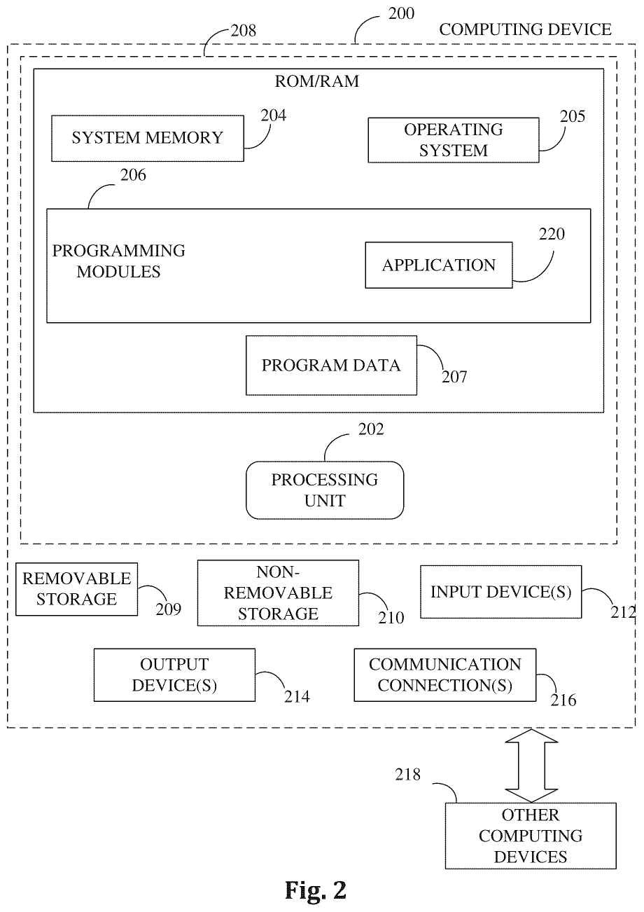

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

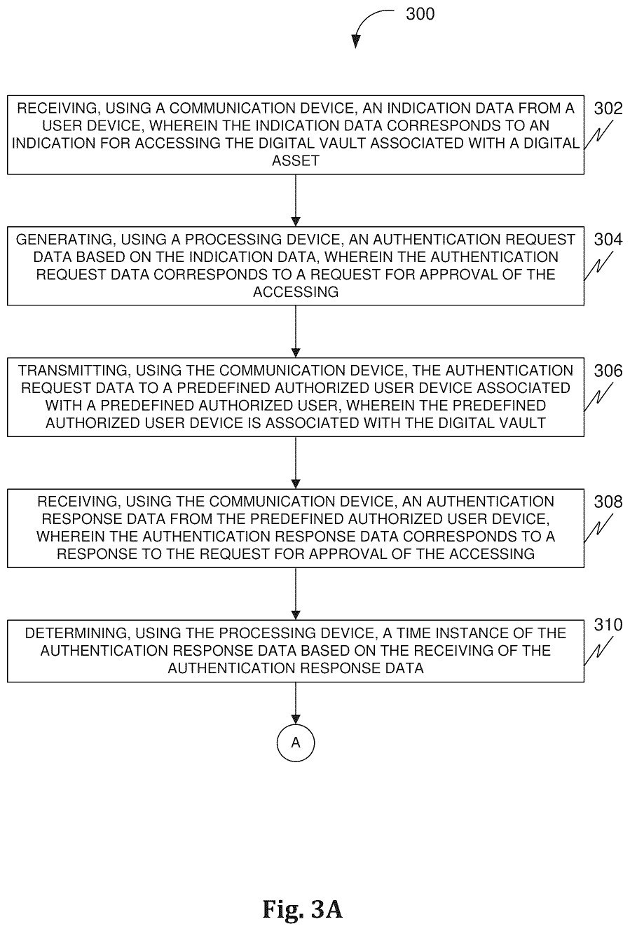

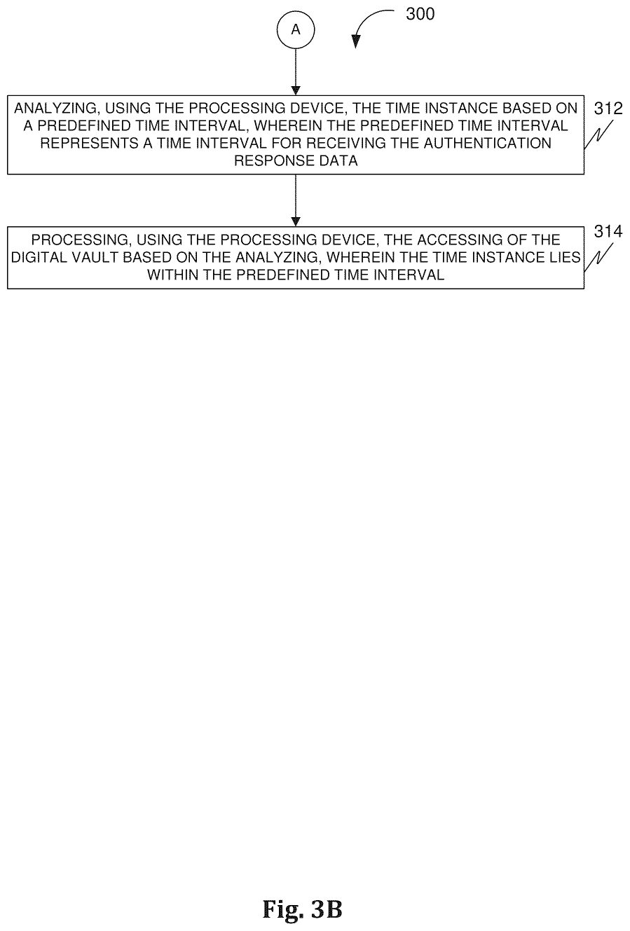

FIG. 3A and FIG. 3B illustrate a flowchart of a method 300 of facilitating protection of a digital vault against an unauthorized access, in accordance with some embodiments.

Accordingly, the method 300 may include a step 302 of receiving, using a communication device 802, an indication data from a user device. Further, the indication data corresponds to an indication for accessing the digital vault associated with a digital asset. Further, the method 300 may include a step 304 of generating, using a processing device 804, an authentication request data based on the indication data. Further, the authentication request data corresponds to a request for approval of the accessing. Further, the method 300 may include a step 306 of transmitting, using the communication device 802, the authentication request data to a predefined authorized user device associated with a predefined authorized user. Further, the predefined authorized user device may be associated with the digital vault. Further, the method 300 may include a step 308 of receiving, using the communication device 802, an authentication response data from the predefined authorized user device. Further, the authentication response data corresponds to a response to the request for approval of the accessing. Further, the method 300 may include a step 310 of determining, using the processing device 804, a time instance of the authentication response data based on the receiving of the authentication response data. Further, the method 300 may include a step 312 of analyzing, using the processing device 804, the time instance based on a predefined time interval. Further, the predefined time interval represents a time interval for receiving the authentication response data. Further, the method 300 may include a step 314 of processing, using the processing device 804, the accessing of the digital vault based on the analyzing. Further, the time instance lies within the predefined time interval.

In some embodiments, the digital vault may be associated with two or more authorized users. Further, the two or more authorized users includes each of a first authorized user and a second authorized user. Further, the authentication response data includes a first authentication response data corresponding to the first authorized user and a second authentication response data corresponding to the second authorized user. Further, the analyzing includes analyzing a first time instance and a second time instance based on a first time interval and a second time interval respectively. Further, the first authentication response data and the second authentication response data may be received at the first time instance and the second time instance respectively. Further, the predefined time interval represents each of the first time interval and the second time interval.

In some embodiments, the predefined time interval corresponds to a block interval representing the time interval between generating of two or more consecutive blocks in a blockchain.

In some embodiments, the method 300 may further include determining, using the processing device 804, a predefined authentication procedure based on the indication data. Further, the predefined authentication procedure corresponds to each of the predefined authorized user and the predefined time interval. Further, the generating of the authentication request data may be further based on the determining.

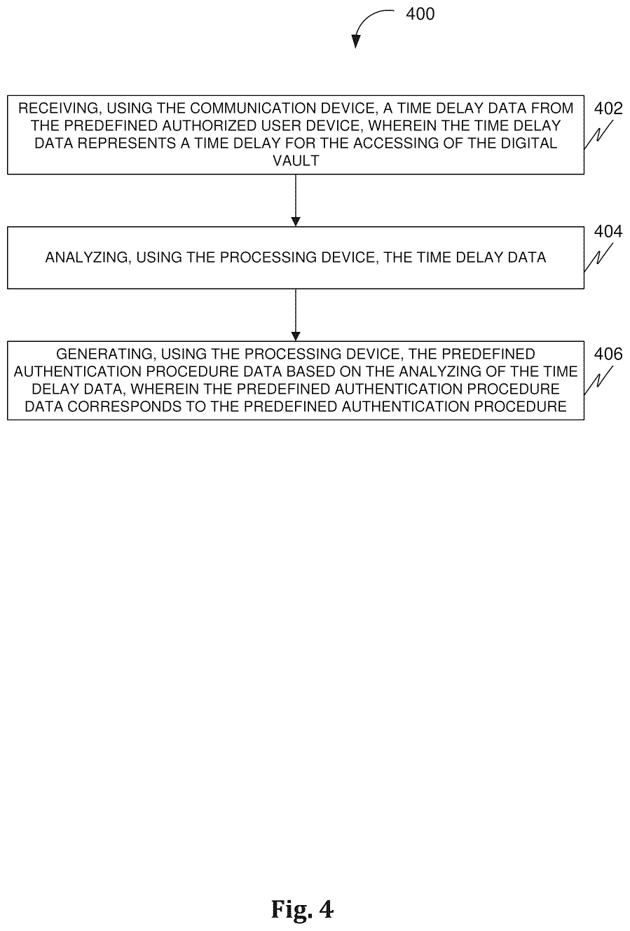

FIG. 4 illustrates a flowchart of a method 400 of facilitating protection of a digital vault against an unauthorized access including generating, using the processing device 804, the predefined authentication procedure data, in accordance with some embodiments.

Further, in some embodiments, the method 400 further may include a step 402 of receiving, using the communication device 802, a time delay data from the predefined authorized user device. Further, the time delay data represents a time delay for the accessing of the digital vault. Further, in some embodiments, the method 400 further may include a step 404 of analyzing, using the processing device 804, the time delay data. Further, in some embodiments, the method 400 further may include a step 406 of generating, using the processing device 804, the predefined authentication procedure data based on the analyzing of the time delay data. Further, the predefined authentication procedure data corresponds to the predefined authentication procedure.

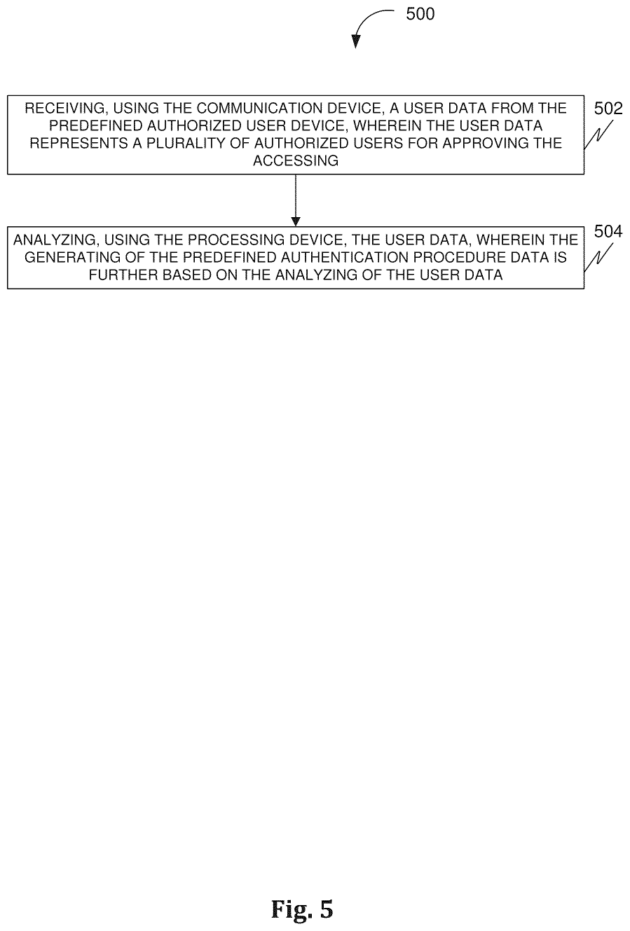

FIG. 5 illustrates a flowchart of a method 500 of facilitating protection of a digital vault against an unauthorized access including analyzing, using the processing device 804, the user data, in accordance with some embodiments.

Further, in some embodiments, the method 500 further may include a step 502 of receiving, using the communication device 802, a user data from the predefined authorized user device. Further, the user data represents two or more authorized users for approving the accessing. Further, in some embodiments, the method 500 further may include a step 504 of analyzing, using the processing device 804, the user data. Further, the generating of the predefined authentication procedure data may be further based on the analyzing of the user data.

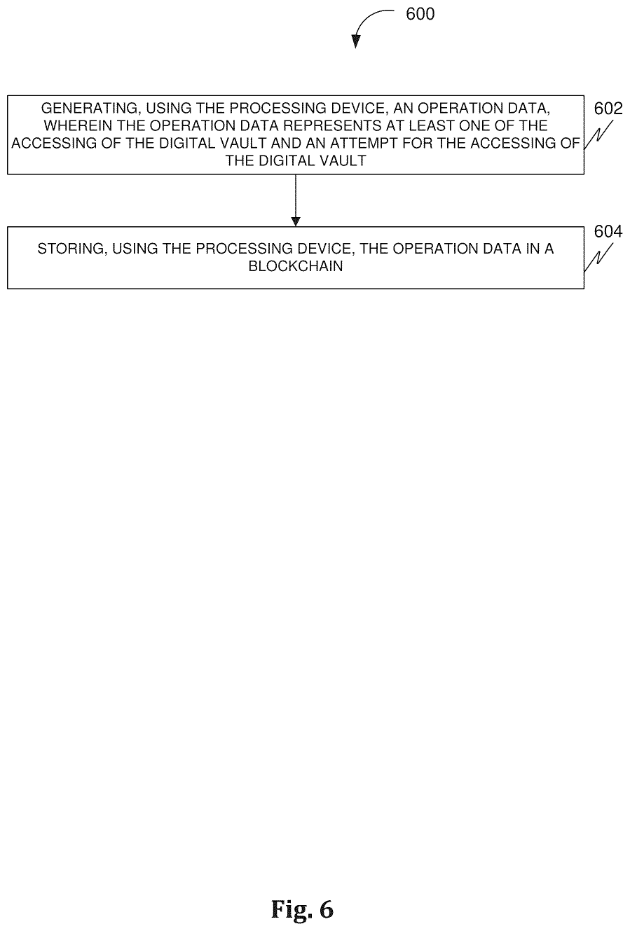

FIG. 6 illustrates a flowchart of a method 600 of facilitating protection of a digital vault against an unauthorized access including generating, using the processing device 804, an operation data, in accordance with some embodiments.

Further, in some embodiments, the method 600 further may include a step 602 of generating, using the processing device 804, an operation data. Further, the operation data represents one or more of the accessing of the digital vault and an attempt for the accessing of the digital vault. Further, in some embodiments, the method 600 further may include a step 604 of storing, using the processing device 804, the operation data in a blockchain.

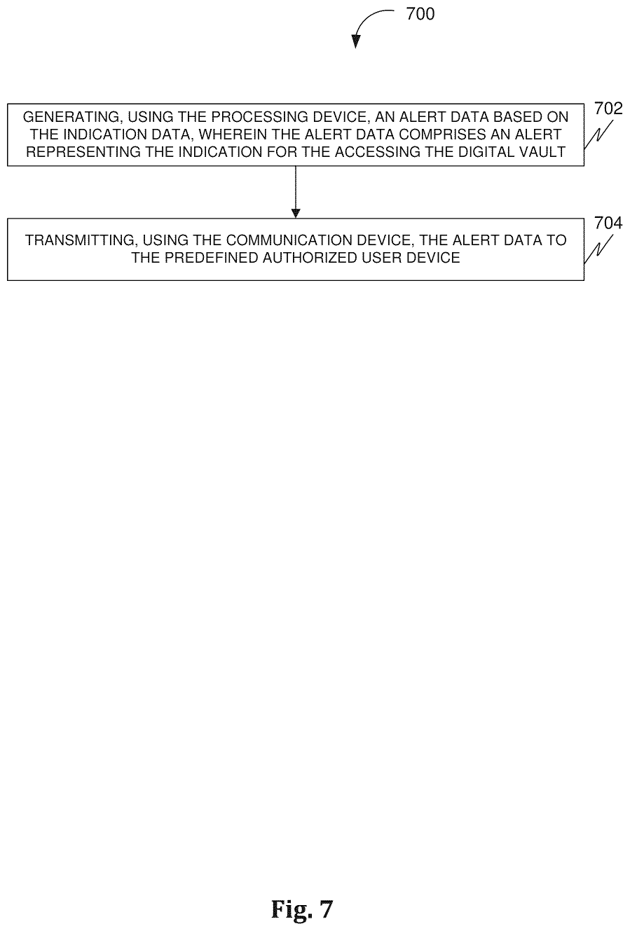

FIG. 7 illustrates a flowchart of a method 700 of facilitating protection of a digital vault against an unauthorized access including generating, using the processing device 804, an alert data, in accordance with some embodiments.

Further, in some embodiments, the method 700 further may include a step 702 of generating, using the processing device 804, an alert data based on the indication data. Further, the alert data includes an alert representing the indication for the accessing the digital vault. Further, in some embodiments, the method 700 further may include a step 704 of transmitting, using the communication device 802, the alert data to the predefined authorized user device.

In some embodiments, the accessing based on the predefined authentication procedure facilitates implementing a time delay between the receiving of the indication data and the processing of the accessing. Further, the processing of the accessing of the digital vault happens after the time delay.

In some embodiments, the method 300 may further include generating, using the processing device 804, a signature data based on the analyzing of the time instance. Further, the signature data corresponds to an additional signature for the approval of the accessing. Further, the processing of the accessing may be further based on the signature data. Further, the accessing of the digital vault may be based on each of the predefined authorized user and the additional signature.

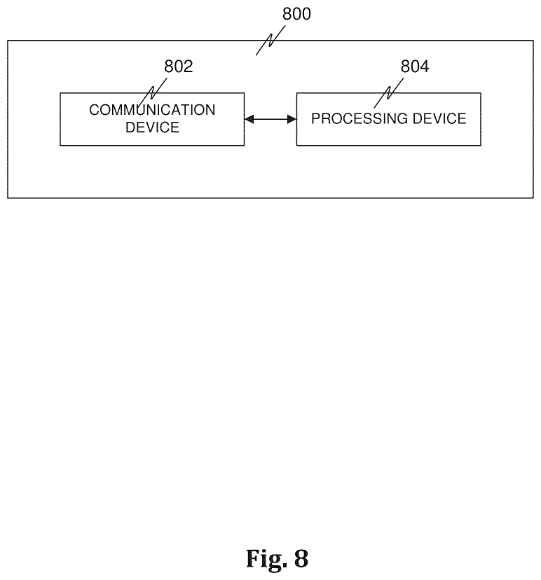

FIG. 8 illustrates a block diagram of a system 800 of facilitating protection of a digital vault against an unauthorized access, in accordance with some embodiments.

Accordingly, the system 800 may include a communication device 802. Further, the communication device 802 may be configured for receiving an indication data from a user device. Further, the indication data corresponds to an indication for accessing the digital vault associated with a digital asset. Further, the communication device 802 may be configured for transmitting an authentication request data to a predefined authorized user device associated with a predefined authorized user. Further, the predefined authorized user device may be associated with the digital vault. Further, the communication device 802 may be configured for receiving an authentication response data from the predefined authorized user device. Further, the authentication response data corresponds to a response to the request for approval of the accessing. Further, the system 800 may include a processing device 804 communicatively coupled with the communication device 802. Further, the processing device 804 may be configured for generating the authentication request data based on the indication data. Further, the authentication request data corresponds to a request for approval of the accessing. Further, the processing device 804 may be configured for determining a time instance of the authentication response data based on the receiving of the authentication response data. Further, the processing device 804 may be configured for analyzing the time instance based on a predefined time interval. Further, the predefined time interval represents a time interval for receiving the authentication response data. Further, the processing device 804 may be configured for processing the accessing of the digital vault based on the analyzing. Further, the time instance lies within the predefined time interval.

In some embodiments, the digital vault may be associated with two or more authorized users. Further, the two or more authorized users includes each of a first authorized user and a second authorized user. Further, the authentication response data includes a first authentication response data corresponding to the first authorized user and a second authentication response data corresponding to the second authorized user. Further, the analyzing includes analyzing a first time instance and a second time instance based on a first time interval and a second time interval respectively. Further, the first authentication response data and the second authentication response data may be received at the first time instance and the second time instance respectively. Further, the predefined time interval represents each of the first time interval and the second time interval.

In some embodiments, the predefined time interval corresponds to a block interval representing the time interval between generating of two or more consecutive blocks in a blockchain.

In some embodiments, the processing device 804 may be further configured for determining a predefined authentication procedure based on the indication data. Further, the predefined authentication procedure corresponds to each of the predefined authorized user and the predefined time interval. Further, the generating of the authentication request data may be further based on the determining.

Further, in some embodiments, the communication device 802 may be further configured for receiving a time delay data from the predefined authorized user device. Further, the time delay data represents a time delay for the accessing of the digital vault. Further, the processing device 804 may be further configured for analyzing the time delay data. Further, the communication device 802 may be further configured for receiving a time delay data from the predefined authorized user device. Further, the processing device 804 may be further configured for generating the predefined authentication procedure data based on the analyzing of the time delay data. Further, the predefined authentication procedure data corresponds to the predefined authentication procedure.

In some embodiments, the communication device 802 may be further configured for receiving a user data from the predefined authorized user device. Further, the user data represents two or more authorized users for approving the accessing. Further, the processing device 804 may be further configured for analyzing the user data. Further, the generating of the predefined authentication procedure data may be further based on the analyzing of the user data.

Further, in some embodiments, the processing device 804 may be further configured for generating an operation data. Further, the operation data represents one or more of the accessing of the digital vault and an attempt for the accessing of the digital vault. Further, the processing device 804 may be further configured for storing the operation data in a blockchain.

In some embodiments, the processing device 804 may be further configured for generating an alert data based on the indication data. Further, the alert data includes an alert representing the indication for the accessing the digital vault. Further, the communication device 802 may be further configured for transmitting the alert data to the predefined authorized user device.

In some embodiments, the accessing based on the predefined authentication procedure facilitates implementing a time delay between the receiving of the indication data and the processing of the accessing. Further, the processing of the accessing of the digital vault happens after the time delay.

In some embodiments, the processing device 804 may be further configured for generating a signature data based on the analyzing of the time instance. Further, the signature data corresponds to an additional signature for the approval of the accessing. Further, the processing of the accessing may be further based on the signature data. Further, the accessing of the digital vault may be based on each of the predefined authorized user and the additional signature.

In some embodiments, the predefined time interval corresponds to a block interval. Further, the first time interval and the second time interval corresponds to generating of a first block and a second block respectively.

In some embodiments, the digital vault may be associated with a blockchain comprising each of the first block and the second block.

In some embodiments, the blockchain corresponds to a liquid network.

In some embodiments, the block interval corresponds to one minute.

In some embodiments, the authentication response data corresponds to two or more cryptographic signatures. Further, the first authentication response data and the second authentication response data corresponds to a first cryptographic signature and a second cryptographic signature respectively. Further, the accessing of the digital vault may be based on each of the first cryptographic signature and the second cryptographic signature.

In some embodiments, the operation data represent an operation time instance. Further, the one or more of the accessing of the digital vault and an attempt for the accessing of the digital vault occurs at the operation time instance.

In some embodiments, the storing of the operation data in the blockchain facilitates a creating of an immutable and transparent log of one or more of two or more accessings of the digital vault and two or more attempts for accessing the digital vault.

In some embodiments, the user device may be associated with the predefined authorized user.

In some embodiments, the accessing of the digital vault may be associated with a transaction of the digital asset. Further, the generating of the authentication request data includes encrypting a transaction detail associated with the transaction to obtain an encrypted transaction detail. Further, the authentication request data represents the request for approval of the transaction with the encrypted transaction detail. Further, the encrypting facilitates maintaining a confidentiality of the transaction.

In some embodiments, the method 300 may be transaction detail corresponds to a value of the digital asset.

In some embodiments, the digital asset corresponds to a sensitive data.

In some embodiments, the time delay enhances a security against the unauthorized access.

In some embodiments, the digital vault may be associate with a blockchain corresponding to a liquid network.

In some embodiments, the liquid network may be characterized by a liquid network characteristic.

In some embodiments, the liquid network characteristics corresponds to one or more of a transaction speed, an enhanced security, a confidentiality and a reliability.

In some embodiments, the liquid network may be based on a liquid script. Further, the liquid script facilitates the implementing of the time delay.

In some embodiments, the liquid script corresponds to one or more of a check lock time verify and a check sequence verify.

In some embodiments, the predefined authentication procedure represents a predetermined cryptographic signature with a respective time instance.

In some embodiments, the transaction of the digital asset corresponds to the transaction of a cryptocurrency.

In some embodiments, the cryptocurrency includes a bitcoin.

In some embodiments, one or more of the receiving of the indication data, transmitting of the authentication request data, and receiving of the authentication response data happens through an application programming interface.

In some embodiments, the indication data, an authentication request data and the authentication response data includes an encrypted indication data, an encrypted authentication request data, and an encrypted authentication response data respectively.

In some embodiments, the digital vault may be associated with a liquid network. Further, one or more of the receiving of the indication data, transmitting of the authentication request data, and receiving of the authentication response data happens through an application programming interface which may be configured to interact with an accelerates mobile page.

In some embodiments, the sensitive data corresponds to a cybersecurity sensitive data.

In some embodiments, the unauthorized access to the sensitive data affects a security of one or more of an individual and an organization.

In some embodiments, the indication corresponds to access a digital wallet.

In some embodiments, the digital wallet corresponds to a private wallet. Further, the private wallet may be configured to control by a user.

In some embodiments, the time delay facilitates providing an additional time for intercepting an unauthorized breach through the unauthorized access.

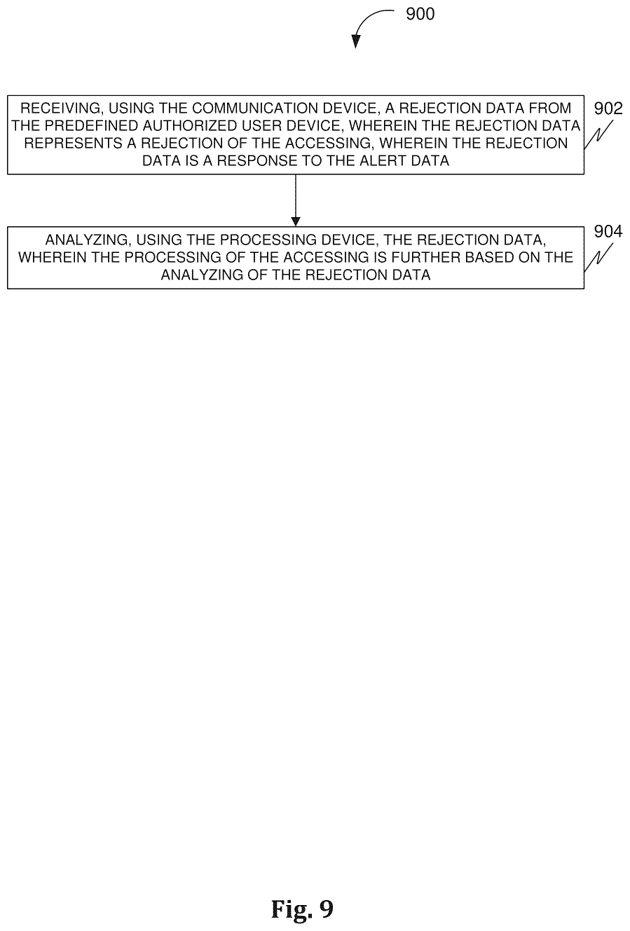

FIG. 9 illustrates a flowchart of a method 900 of facilitating protection of a digital vault against an unauthorized access including analyzing, using the processing device 804, the rejection data, in accordance with some embodiments.

Further, in some embodiments, the method 900 further may include a step 902 of receiving, using the communication device 802, a rejection data from the predefined authorized user device. Further, the rejection data represents a rejection of the accessing. Further, the rejection data may be a response to the alert data. Further, in some embodiments, the method 900 further may include a step 904 of analyzing, using the processing device 804, the rejection data. Further, the processing of the accessing may be further based on the analyzing of the rejection data.

In some embodiments, the unauthorized access corresponds to one or more of a digital security breach and a physical security breach.

In some embodiments, the indication corresponds to an accessing of a primary digital wallet. Further, the method 700 further includes transmitting, using the communication device 802, the alert data to a secondary digital wallet. Further, the predefined authorized user may be associated with each of the primary digital wallet and the secondary digital wallet.

In some embodiments, the primary digital wallet may be associated with the digital asset. Further, the accessing may be associated with a transaction of the digital asset.

In some embodiments, the rejection data may be received during a time delay.

In some embodiments, one or more of the generating of the authentication request data, the transmitting of the authentication request data, the receiving of the authentication response data, and the analyzing of the authentication response data occurs during the time delay.

In some embodiments, the predefined authorized user device includes a predefined authorized user presentation device. Further, one or more of the time delay data and the user data may be based on an interaction of the predefined authorized user with a graphical user interface. Further, the predefined authorized user presentation device may be configured to present the graphical user interface.

In some embodiments, the digital vault corresponds to a multi-signature vault. Further, the multi-signature vault may be configured to be accessed based on two or more signatures.

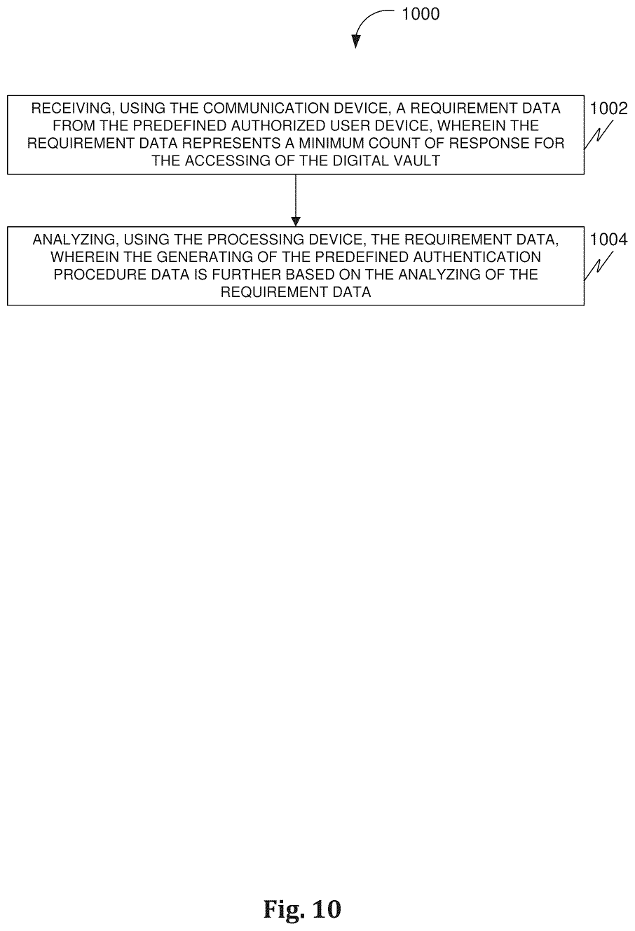

FIG. 10 illustrates a flowchart of a method 1000 of facilitating protection of a digital vault against an unauthorized access including analyzing, using the processing device 804, the requirement data, in accordance with some embodiments.

Further, in some embodiments, the method 1000 further may include a step 1002 of receiving, using the communication device 802, a requirement data from the predefined authorized user device. Further, the requirement data represents a minimum count of response for the accessing of the digital vault. Further, in some embodiments, the method 1000 further may include a step 1004 of analyzing, using the processing device 804, the requirement data. Further, the generating of the predefined authentication procedure data may be further based on the analyzing of the requirement data.

In some embodiments, the digital vault may be associated with three authorized users. Further, the minimum count of response corresponds to two.

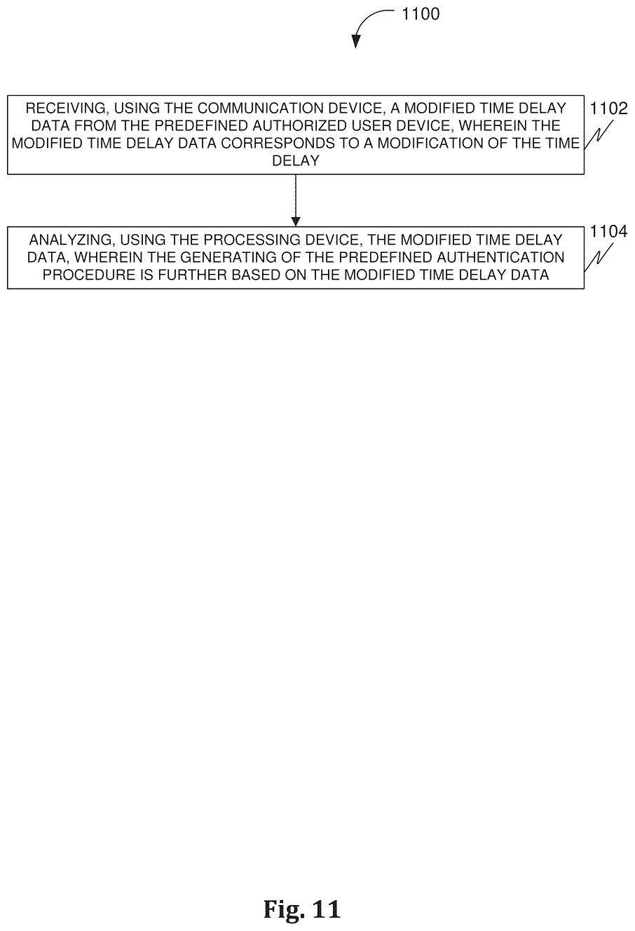

FIG. 11 illustrates a flowchart of a method 1100 of facilitating protection of a digital vault against an unauthorized access including analyzing, using the processing device 804, the modified time delay data, in accordance with some embodiments.

Further, in some embodiments, the method 1100 further may include a step 1102 of receiving, using the communication device 802, a modified time delay data from the predefined authorized user device. Further, the modified time delay data corresponds to a modification of the time delay. Further, in some embodiments, the method 1100 further may include a step 1104 of analyzing, using the processing device 804, the modified time delay data. Further, the generating of the predefined authentication procedure may be further based on the modified time delay data.

In some embodiments, the accessing based on the predefined authentication procedure may be associated with the time delay. Further, the time delay may be associated with a first value. Further, the modification of the time delay represents a second value.

In some embodiments, the generating of the predefined authentication procedure based on the modified time delay data may be further based on a value of the time delay at a specific time instance.

In some embodiments, the value of the time delay at the specific time instance may be equal to the first value.

In some embodiments, the indication data represents a unique identifier of a beneficiary.

In some embodiments, the processing the accessing includes the processing of the transaction based on the unique identifier.

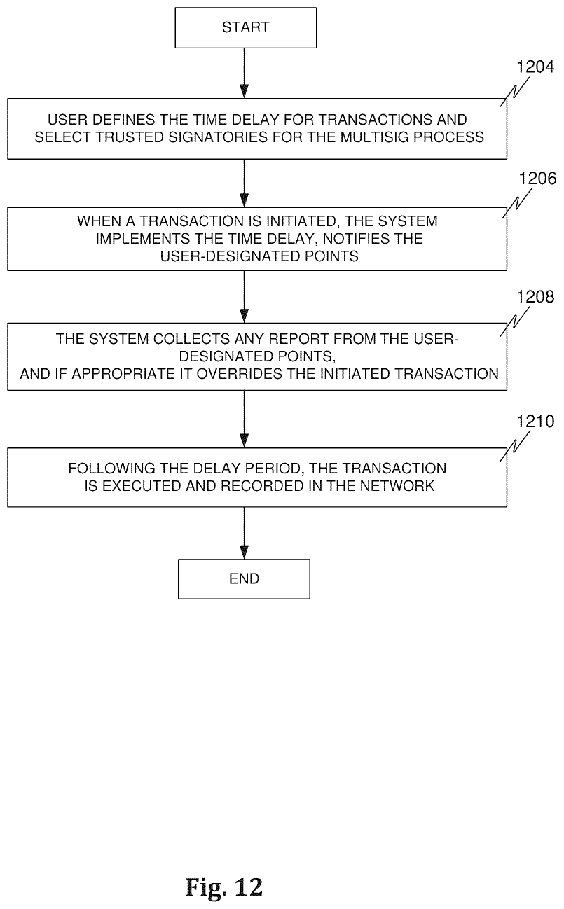

FIG. 12 illustrates a flowchart of a method of time delayed and multisig-enhanced security solution for digital assets management, in accordance with some embodiments. Further, the method may include a step 1204, where user defines the time delay for transactions and select trusted signatories for the multisig process. Further, the method may include a step 1206, where a transaction is initiated and the system implements the time delay and notifies the user-designated points. Further, the method may include a step 1208, where the system collects any report from the user-designated points. Further, it may override the initiated transaction. Further, the method may include a step 1210, where the transaction is executed and recorded in the network after the delay period.

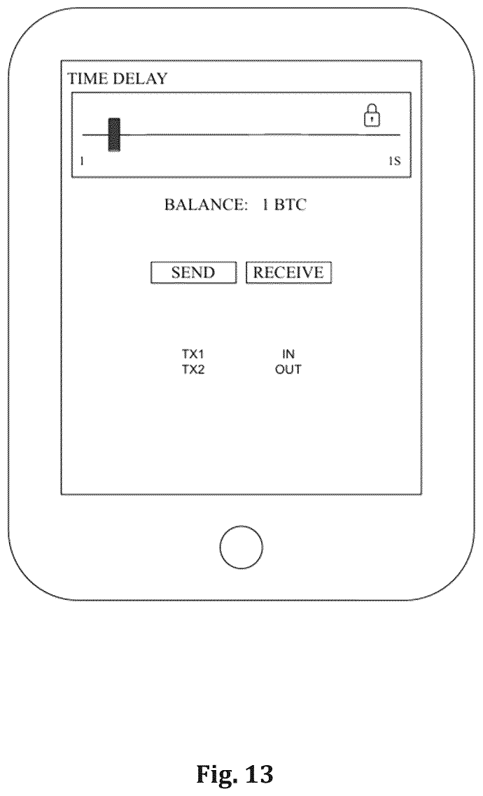

FIG. 13 illustrates a simplifies end-view of the user interface of the user wallet, in accordance with some embodiments. Further, the user interface allows the user for one or more of managing a crypto asset transaction, setting a time delay, and establishing a multisig configuration.

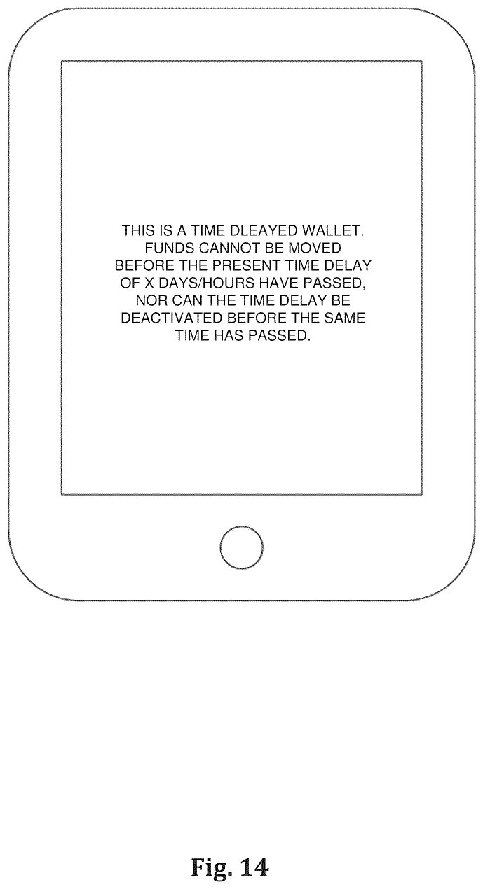

FIG. 14 illustrates a simplified end-view of the transaction scheduler, in accordance with some embodiments. Further, the transaction scheduler corresponds to a backend component configured for one or more of enforcing the user-set delay for transactions and managing the queuing and timed release of transaction approval.

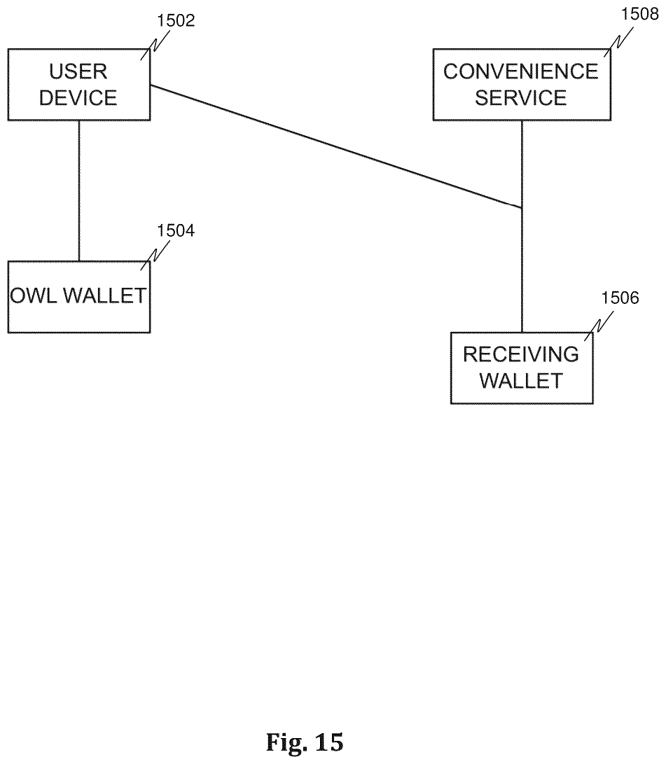

FIG. 15 illustrates a simplified end-view of the notification dispatcher, in accordance with some embodiments. Further, the notification dispatcher is configured to send out real-time encrypted alert to one or more of a user device 1502 and an external owl wallet 1504. Further the user device is associated with a receiving wallet 1506. Further, the receiving wallet is based on a cosigning service 1508.

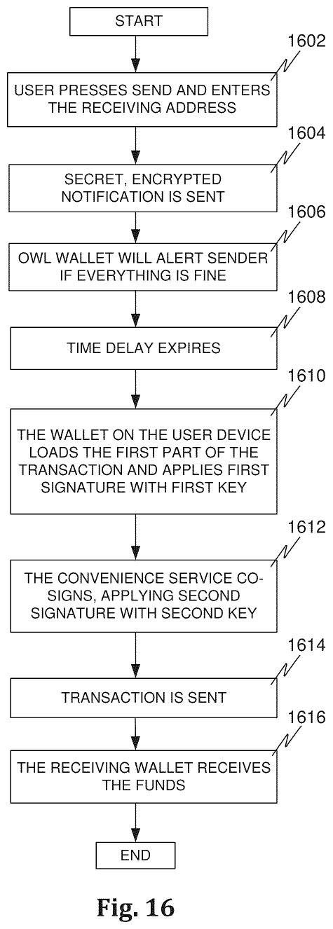

FIG. 16 illustrates a simplified end-view of the cosigning service, in accordance with some embodiments. Further, the cosigning service may include a step 1602, where user presses and enters the receiving address. Further, the cosigning service may include a step 1604, where secret and encrypted notification is sent. Further, the cosigning service may include a step 1606, where owl wallet will alert sender if everything is fine. Further, the cosigning service may include a step 1608, where time delay expires. Further, the cosigning service may include a step 1610, where the wallet on the user device loads the first part of the transaction and applies first signature with first key. Further, the cosigning service may include a step 1612 of providing cosigns and applying second signature with second key. Further, the cosigning service may include a step 1614 of sending a transaction. Further, the cosigning service may include a step 1616, where the receiving wallet receives the funds.

Although the invention has been explained in relation to its preferred embodiment, it is to be understood that many other possible modifications and variations can be made without departing from the spirit and scope of the invention as hereinafter claimed.

1. A method of facilitating protection of a digital vault against an unauthorized access, the method comprising:
receiving, using a communication device, an indication data from a user device, wherein the indication data corresponds to an indication for accessing the digital vault associated with a digital asset;
generating, using a processing device, an authentication request data based on the indication data, wherein the authentication request data corresponds to a request for approval of the accessing;
transmitting, using the communication device, the authentication request data to a predefined authorized user device associated with a predefined authorized user, wherein the predefined authorized user device is associated with the digital vault;
receiving, using the communication device, an authentication response data from the predefined authorized user device, wherein the authentication response data corresponds to a response to the request for approval of the accessing;
determining, using the processing device, a time instance of the authentication response data based on the receiving of the authentication response data;
analyzing, using the processing device, the time instance based on a predefined time interval, wherein the predefined time interval represents a time interval for receiving the authentication response data; and
processing, using the processing device, the accessing of the digital vault based on the analyzing, wherein the time instance lies within the predefined time interval.

2. The method of claim 1, wherein the digital vault is associated with a plurality of authorized users, wherein the plurality of authorized users comprises each of a first authorized user and a second authorized user, wherein the authentication response data comprises a first authentication response data corresponding to the first authorized user and a second authentication response data corresponding to the second authorized user, wherein the analyzing comprises analyzing a first time instance and a second time instance based on a first time interval and a second time interval respectively, wherein the first authentication response data and the second authentication response data is received at the first time instance and the second time instance respectively, wherein the predefined time interval represents each of the first time interval and the second time interval.

3. The method of claim 1, wherein the predefined time interval corresponds to a block interval representing the time interval between generating of a plurality of consecutive blocks in a blockchain.

4. The method of claim 1 further comprises determining, using the processing device, a predefined authentication procedure based on the indication data, wherein the predefined authentication procedure corresponds to each of the predefined authorized user and the predefined time interval, wherein the generating of the authentication request data is further based on the determining.

5. The method of claim 4 further comprises:
receiving, using the communication device, a time delay data from the predefined authorized user device, wherein the time delay data represents a time delay for the accessing of the digital vault;
analyzing, using the processing device, the time delay data; and
generating, using the processing device, the predefined authentication procedure data based on the analyzing of the time delay data, wherein the predefined authentication procedure data corresponds to the predefined authentication procedure.

6. The method of claim 5 further comprises:
receiving, using the communication device, a user data from the predefined authorized user device, wherein the user data represents a plurality of authorized users for approving the accessing; and
analyzing, using the processing device, the user data, wherein the generating of the predefined authentication procedure data is further based on the analyzing of the user data.

7. The method of claim 1 further comprises:
generating, using the processing device, an operation data, wherein the operation data represents at least one of the accessing of the digital vault and an attempt for the accessing of the digital vault; and
storing, using the processing device, the operation data in a blockchain.

8. The method of claim 1 further comprises:
generating, using the processing device, an alert data based on the indication data, wherein the alert data comprises an alert representing the indication for the accessing the digital vault; and
transmitting, using the communication device, the alert data to the predefined authorized user device.

9. The method of claim 1, wherein the accessing based on the predefined authentication procedure facilitates implementing a time delay between the receiving of the indication data and the processing of the accessing, wherein the processing of the accessing of the digital vault happens after the time delay.

10. The method of claim 1 further comprises generating, using the processing device, a signature data based on the analyzing of the time instance, wherein the signature data corresponds to an additional signature for the approval of the accessing, wherein the processing of the accessing is further based on the signature data, wherein the accessing of the digital vault is based on each of the predefined authorized user and the additional signature.

11. A system for facilitating protection of a digital vault against an unauthorized access, the system comprising:
a communication device configured for:
receiving an indication data from a user device, wherein the indication data corresponds to an indication for accessing the digital vault associated with a digital asset;
transmitting an authentication request data to a predefined authorized user device associated with a predefined authorized user, wherein the predefined authorized user device is associated with the digital vault;
receiving an authentication response data from the predefined authorized user device, wherein the authentication response data corresponds to a response to the request for approval of the accessing;
a processing device configured for:
generating the authentication request data based on the indication data, wherein the authentication request data corresponds to a request for approval of the accessing;
determining a time instance of the authentication response data based on the receiving of the authentication response data;
analyzing the time instance based on a predefined time interval, wherein the predefined time interval represents a time interval for receiving the authentication response data; and
processing the accessing of the digital vault based on the analyzing, wherein the time instance lies within the predefined time interval.

12. The system of claim 11, wherein the digital vault is associated with a plurality of authorized users, wherein the plurality of authorized users comprises each of a first authorized user and a second authorized user, wherein the authentication response data comprises a first authentication response data corresponding to the first authorized user and a second authentication response data corresponding to the second authorized user, wherein the analyzing comprises analyzing a first time instance and a second time instance based on a first time interval and a second time interval respectively, wherein the first authentication response data and the second authentication response data is received at the first time instance and the second time instance respectively, wherein the predefined time interval represents each of the first time interval and the second time interval.

13. The system of claim 11, wherein the predefined time interval corresponds to a block interval representing the time interval between generating of a plurality of consecutive blocks in a blockchain.

14. The system of claim 11, wherein the processing device is further configured for determining a predefined authentication procedure based on the indication data, wherein the predefined authentication procedure corresponds to each of the predefined authorized user and the predefined time interval, wherein the generating of the authentication request data is further based on the determining.

15. The system of claim 14, wherein the communication device is further configured for receiving a time delay data from the predefined authorized user device, wherein the time delay data represents a time delay for the accessing of the digital vault, wherein the processing device is further configured for:
analyzing the time delay data; and
generating the predefined authentication procedure data based on the analyzing of the time delay data, wherein the predefined authentication procedure data corresponds to the predefined authentication procedure.

16. The system of claim 15, wherein the communication device is further configured for receiving a user data from the predefined authorized user device, wherein the user data represents a plurality of authorized users for approving the accessing, wherein the processing device is further configured for analyzing the user data, wherein the generating of the predefined authentication procedure data is further based on the analyzing of the user data.

17. The system of claim 11, wherein the processing device is further configured for:
generating an operation data, wherein the operation data represents at least one of the accessing of the digital vault and an attempt for the accessing of the digital vault; and
storing the operation data in a blockchain.

18. The system of claim 11, wherein the processing device is further configured for generating an alert data based on the indication data, wherein the alert data comprises an alert representing the indication for the accessing the digital vault, wherein the communication device is further configured for transmitting the alert data to the predefined authorized user device.

19. The system of claim 11, wherein the accessing based on the predefined authentication procedure facilitates implementing a time delay between the receiving of the indication data and the processing of the accessing, wherein the processing of the accessing of the digital vault happens after the time delay.

20. The system of claim 11, wherein the processing device is further configured for generating a signature data based on the analyzing of the time instance, wherein the signature data corresponds to an additional signature for the approval of the accessing, wherein the processing of the accessing is further based on the signature data, wherein the accessing of the digital vault is based on each of the predefined authorized user and the additional signature.
